(19) United States
(12) Patent Application Publication
(10) Pub. No.: US 2025/0177924 A1
(43) Pub. Date: Jun. 5, 2025

(54) IN-SITU REPAIR METHOD FOR THE SURFACE OF PA MEMBRANE AFTER THE DESTRUCTION OF OXIDIZING SUBSTANCES

(71) Applicant: Northwestern Polytechnical University, Xi'an (CN)

(72) Inventors: Miao TIAN, Xi'an (CN); Qiuyu ZHANG, Xi'an (CN); Huan WANG, Xi'an (CN); Haiqing HUI, Xi'an (CN); Wen HAO, Xi'an (CN); Wen WANG, Xi'an (CN)

(73) Assignee: Northwestern Polytechnical University, Xi'an (CN)

(21) Appl. No.: 18/915,470

(22) Filed: Oct. 15, 2024

(30) Foreign Application Priority Data
Dec. 4, 2023 (CN) 202311646460.7

(51) Int. Cl. B01D 65/10; B01D 71/40

(52) U.S. Cl. CPC B01D 65/108; B01D 71/40; B01D 2321/166; B01D 2321/168; B01D 2321/28

(57) ABSTRACT

An in-situ repair method for the surface of polyamide (PA) membrane after the destruction of oxidizing substances is provided. Lysozyme solution is mixed with tris (2-carboxyethyl) phosphine (TCEP) buffer solution, and the PA membrane to be repaired is immersed in the mixed solution, after being taken out, the PA membrane to be repaired is rinsed, and the nano-protein coating with uniform changes in pore size, charge density and thickness is obtained on the surface of the PA membrane to be repaired. Then the amine solution modification is used, the surface of the nano-protein coating is grafted by amines, and the repaired PA membrane is obtained. The PA membrane to be repaired is immersed in a mixed solution for 1-24 h. The PA membrane repaired by nano-coating has a water permeability of 11.4 Lm⁻²L⁻¹bar⁻¹ (LMH/bar) and a rejection rate of 98.5% to magnesium chloride for the nanofiltration (NF) membrane after strong chlorine destruction.

### CROSS REFERENCE TO THE RELATED APPLICATIONS

This application is based upon and claims priority to Chinese Patent Application No. 202311646460.7, filed on Dec. 4, 2023, the entire contents of which are incorporated herein by reference.

### TECHNICAL FIELD

The invention belongs to the application field of water treatment membrane and the field of environmental protection, and relates to an in-situ repair method for the surface of polyamide (PA) membrane after the destruction of oxidizing substances, it is a simple repair method and membrane module repair process, which is easy to industrialize and enlarge the performance of nanofiltration membrane and reverse osmosis membrane destructed by oxidizing cleaning agent and with polyamide as separation layer. The method of the invention can be applied to the fields of seawater desalination pretreatment, water purification and heavy metal resource recovery.

### BACKGROUND

The steady growth of population and the rapid development of industrialization have accelerated the increase in demand for fresh water. In order to solve the problem of water shortage and environmental protection, wastewater treatment and resource reuse are the key to sustainable development. As an emerging technology, membrane technology has shown excellent performance in the fields of municipal wastewater treatment, seawater desalination, industrial wastewater treatment and resource utilization.

Among them, the separation membranes based on reverse osmosis membrane (RO) and nanofiltration membrane (NF) can achieve the goal of separating water molecules and salt ions, monovalent ions and divalent ions through dissolution permeation theory, size effect and Donnan effect respectively, and the application scenarios are extremely extensive. At present, the separation layer of NF membrane and RO membrane materials can be divided into two categories: aromatic polyamide (PA) and cellulose acetate (CA). Among them, CA membrane has good chlorine resistance, but its pH tolerance range is narrow, it is vulnerable to microbial erosion and easy to creep under high pressure, resulting in irreversible flux decline. Compared with CA membrane, PA membrane is stable in a wide pH range and has good separation characteristics, which is an ideal separation material. However, the PA separation membrane has poor tolerance to free chlorine and is easily oxidized and degraded by the added disinfectants (such as Cl₂, NaClO, etc.) during the pretreatment of raw water, resulting in short membrane life and high replacement frequency of membrane module. According to incomplete statistics, under the condition that the existing PA membrane has not been fully popularized in our national drinking water plant, more than 14,000 tons of RO membrane elements are discarded worldwide every year, causing serious environmental problems. It is urgent to develop efficient repair method for PA membrane. Although activated carbon adsorption can be used to remove residual free chlorine in the disinfection process in the industrial water treatment process, activated carbon adsorption will increase operating cost and process complexity. The most effective and environmentally friendly method is to develop antioxidant PA membrane or PA membrane repair method. Academia and industry have developed methods to improve the oxidation resistance of PA membrane: coating, graft polymerization, development of new monomer, and addition of nanomaterials (carbon nanotubes, graphene oxide).

On the surface of the destructed polyamide separation layer, the nano-protein coating is used as the intermediate layer, and amines (such as polypropylene imine PPI, polyamidoamine PAMAM, polyvinylamine PVAm, Polydiallyldimethylammonium chloride (PDADMAC), etc.) are grafted on the surface of the destructed polyamide separation layer to form a repair coating. The coating can repair the pore size of the PA selective layer after NaClO destruction, regulate the pore size and surface electrical property of the membrane. In the example, this repair coating can be easily constructed on the surface of PA eroded by oxidants such as NaClO, and the rejection performance of the PA separation layer to divalent salt after strong chlorine attack can be repaired by 100%.

### SUMMARY

### Technical Problems to be Solved

In order to avoid the shortcomings of the existing technology, the invention proposes an in-situ repair method for the surface of PA membrane after the destruction of oxidizing substances, the core is to provide a repair method for the surface of PA membrane after the strong chlorine (NaClO) destruction, so as to realize the better recovery of the separation characteristics of PA membrane. The invention reconstructs the surface of PA membrane after strong chlorine attack by using a nano-coating material based on natural extract, and obtains obvious repair effect. The method is simple and fast, and the raw materials are all non-toxic, harmless and easy to obtain, so that the method is also suitable for large-scale industrial production.

### Technical Scheme

An in-situ repair method for a surface of PA membrane after a destruction of oxidizing substances is characterized by: a lysozyme solution is used to mix with a tris (2-carboxyethyl) phosphine (TCEP) buffer solution, a PA membrane to be repaired is immersed in a mixed solution, and the PA membrane to be repaired is rinsed after being taken out, on a surface of the PA membrane to be repaired, a nano-protein coating with uniform changes in pore size, charge density and thickness is obtained; then, an amine solution modification is used, so that the surface of the nano-protein coating is grafted with amines to obtain a repaired PA membrane; the PA membrane to be repaired is immersed in the mixed solution for 1-24 h.

A method for grafting amine on a surface of nano-protein coating by using amine solution modification is as follows: the PA membrane to be repaired with nano-protein coating is treated in 20-80° C. and 0.1-10 g/L amine solution for 1-10 h, and then the surface of the membrane is rinsed with clean water.

The lysozyme solution is 1-50 mg/ml lysozyme dissolved in 2-300 mM 4-(2-hydroxyethyl) piperazine-1-ethanesulfonic acid (HEPES) solution.

The tris (2-carboxyethyl) phosphine (TCEP) buffer solution is 1-200 mM tris (2-carboxyethyl) phosphine (TCEP) dissolved in HEPES solution.

A pH of the lysozyme solution is 4.0-8.0.

A pH of the tris (2-carboxyethyl) phosphine (TCEP) buffer solution is 2.0-7.0.

The lysozyme adopts a natural antibacterial enzyme, and the lysozyme is extracted by egg white.

A thickness of the nano-coating is 20-150 nm.

The in-situ repair method for the surface of PA membrane after the destruction of oxidizing substances is used for an on-line repair method for membrane module without disassembling the membrane module. Its characteristics are as follows: at an installation site of membrane module, after cleaning the membrane module by using an on-line cleaning system, a cleaning agent solution pool is replaced by a mixed solution of lysozyme solution and tris (2-carboxyethyl) phosphine (TCEP) buffer solution, then the mixed solution is pumped into a membrane module to be repaired, and a reaction, a reaction solution in the system is discharged and cleaned. The nano-protein coating with the uniform changes in pore size, charge density and thickness is obtained on the surface of the PA membrane to be repaired. Besides, the cleaning agent solution pool is replaced with the amine solution, which is pumped into the membrane module to be repaired, after the modification, the reaction solution in the system is discharged and cleaned, so that the surface of the nano-protein coating is grafted with amine substance and the PA membrane of the membrane module is repaired.

The in-situ repair method for the surface of PA membrane after the destruction of oxidizing substances and the PA membrane repaired by the on-line repair method without disassembling the membrane module, which are characterized in that: for the NF membrane after destruction, its water permeability reaches 11.4 Lm⁻²L⁻¹bar⁻¹(LMH/bar), and its rejection rate to magnesium chloride reaches 98.5%, compared with the membrane before the strong chlorine destruction, its rejection rate to Mg²⁺ restores 100% while maintaining the water permeability.

### Beneficial Effects

The invention proposes an in-situ repair method for the surface of PA membrane after the destruction of oxidizing substances. The raw material lysozyme used in the invention is a natural antibacterial enzyme with a wide range of sources, which can undergo phase transition under appropriate condition. When lysozyme is mixed with tris (2-carboxyethyl) phosphine (TCEP) buffer solution at neutral pH, it can be converted into an insoluble superstructure. In this process, the α-helix structure of the natural lysozyme is expanded and then assembled into a β-sheet structure after the disulfide bond of the lysozyme chain is reduced by TCEP, so that an oligomer is formed. Then, the oligomer preferentially aggregates at the air/water interface to form a two-dimensional phase-transforming lysozyme (PTL) nano-membrane. Therefore, after the PA membrane is immersed in this mixed solution, the oligomer with sheet structure can aggregate on the surface of the PA membrane, that is, a new layer is formed on the surface of the nanofiltration membrane. This nano repair layer can play a role in regulating the pore size and charge of the original PA membrane, by adjusting the pore size and the chemical structure of the repair agent, the recovery or improvement of the rejection ability of the PA membrane to different types of ions after repair can be achieved. The PA membrane repair coating prepared by the invention has obvious effect of performance repair on the nanofiltration membrane after strong chlorine destruction. Taking the common nanofiltration PA membrane as an example, the PA membrane repaired by nano-coating prepared by the invention has a water permeability of 11.4 Lm⁻²L⁻¹bar⁻¹ (LMH/bar) to the NF membrane after strong chlorine destruction and a rejection rate of 98.5% to magnesium chloride, compared with the membrane before strong chlorine destruction, a rejection rate to Mg²⁺ is almost restored to 100% while maintaining the water permeability.

Compared with the existing technology, the invention has the following advantages:

1. Based on the lysozyme nano-coating prepared by the previous patent 202211105923.4, the invention further improves the positive charge density of the membrane surface by using amine reagent for secondary grafting reaction. Among them, the molecular weight and chemical structure of different amine reagents affect the efficiency of secondary grafting reaction, thus affecting the surface pore size and charge density, and ultimately affecting the surface characteristics of PA layer.

2. The study finds that the PTL coating can be used as a chlorine-resistant protective layer of the PA membrane to improve the stability of the membrane; on the basis of this result, we expose the obtained amine-enhanced positively charged PA membrane to 1000 mg/L NaClO aqueous solution (pH about 11) for 30 h and find that the PTL nano-protein layer can protect the membrane from chlorine erosion to ensure the divalent salt rejection.

3. At the same time, the PTL nano-coating acts as a sacrificial layer after NaClO oxidation. Based on this finding, we will re-construct the repair coating on the surface of the PA membrane after NaClO destruction, and obtain a method that can restore the high rejection rate of the NF membrane after strong chlorine destruction to divalent cation. This method is simple and convenient, its effect is obvious, and it has good applicability.

4. In addition, the material liquid of repair coating can be directly injected into the membrane module, and the excess material liquid can be eliminated after staying for the best time, and the in-situ repair of the membrane module can be realized. The repair method has the advantages of simple operation process, green and easy availability of raw material, and the process can be directly applied to industrial mass production.

5. The nano-coating repair method developed in this invention is more economical than the ultrafiltration membrane formed by the direct destruction of RO membrane and NF membrane with PA as the selection layer in the past. We use the repair coating for the destructed RO membrane and find that under the condition of ensuring the water permeation flux, the rejection rate of the repaired RO membrane to monovalent cation increases by nearly 90%, and its rejection rate of divalent cation increases by 103%.

6. This repair method has mild reaction temperature, simple process and strong practicability. It is suitable for flat membrane, hollow fiber membrane, etc. Due to the mild reaction and simple step of this method, online repair of membrane module including plate-frame and spiral-wound membrane modules can be carried out without disassembling the membrane modules, which can further save time and economic cost. The repair method and schematic diagram of the membrane module are shown in FIG. 4. General industrial membrane modules include automatic online cleaning process, the repair method can be used in combination with the online cleaning process. In the installation site of the membrane module, after cleaning the membrane module with an online cleaning system, the cleaning agent solution pool is replaced with a repair solution, and the composition of the reaction solution and the solution involved in the repair scheme are pumped into the membrane module to be repaired, so as to control the environmental factors such as solution residence time (i.e. reaction time) and reaction temperature. After the reaction, the reaction solution in the system is discharged, and the membrane module can be put into use after cleaning with water and testing its performance after repair.

### BRIEF DESCRIPTION OF THE DRAWINGS

FIGS. 1A-1C are the comparison diagrams of water permeation flux and divalent salt rejection rate of PA membrane coating of Ratio 1 before and after 1000 mg/L NaClO destruction for 30 h; wherein FIG. 1A shows the performance analysis of PA membrane before NaClO treatment; FIG. 1B shows the performance analysis of PA membrane after NaClO treatment; FIG. 1C shows the performance analysis of PA membrane after secondary construction of repair coating; it can be seen that the water flux stability before and after the repair in the embodiment is good, especially the water flux after the repair is maintained above 10 LMH/bar. The rejection rate of the repaired membrane to Mg² (95%-98%) is generally higher than that of the unrepaired membrane (84%-91%).

FIGS. 2A-2C are SEM images of NF membrane surface before and after repair. It can be seen that the surface of the repaired membrane is denser and flatter than that of the membrane after NaClO treatment.

FIGS. 3A-3C are the TEM images of NF membrane cross section before and after repair. It can be seen that the thickness of PA layer after NaClO treatment is significantly reduced, and the thickness of PA layer after coating the repair coating is increased by 10 nm. The PA layer is controlled in a relatively thin range, which is beneficial to obtain high water permeability and excellent separation performance at the same time.

FIG. 4 shows the membrane module repair method and schematic diagram. The membrane module repair scheme involves environmental factors such as the composition of the reaction solution, the residence time of the solution in the module, and the reaction temperature.

FIGS. 5A-5B are the surface morphologies of the actual waste membrane before and after repair.

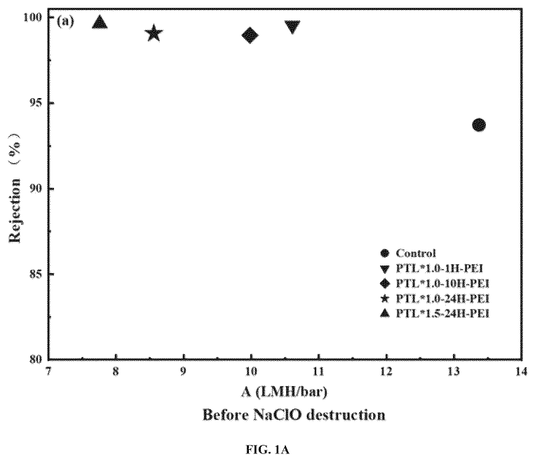

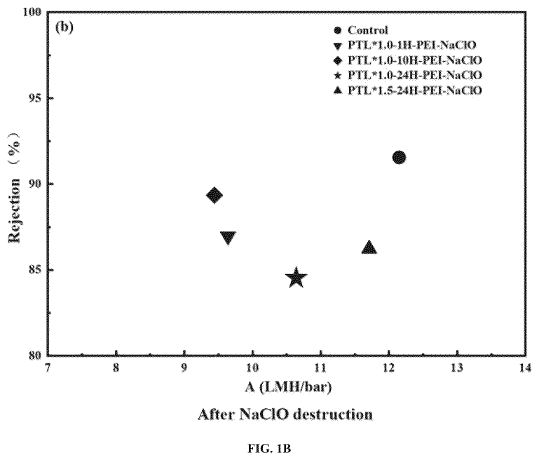

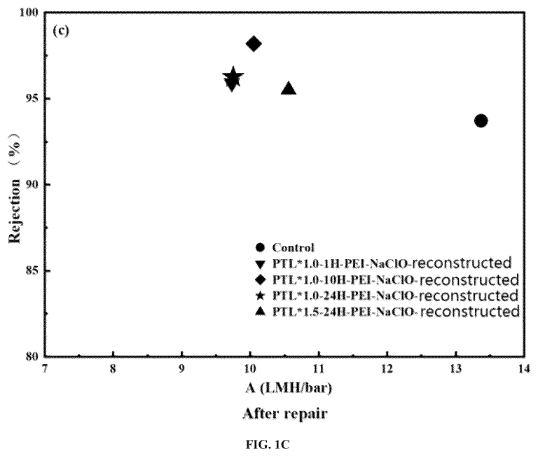

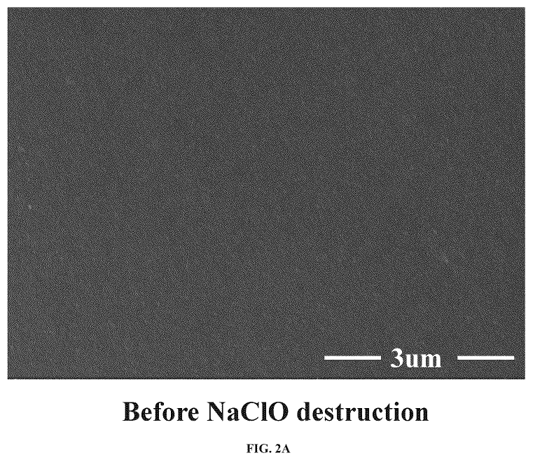

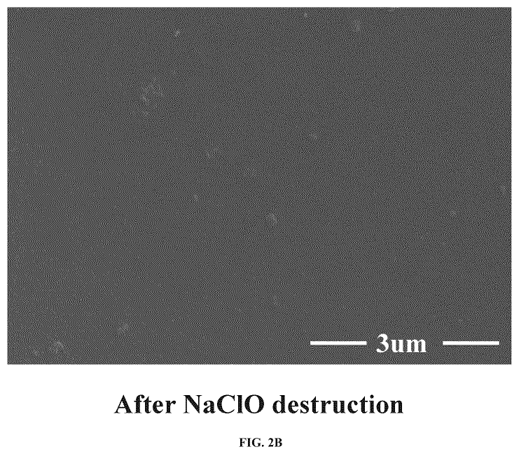

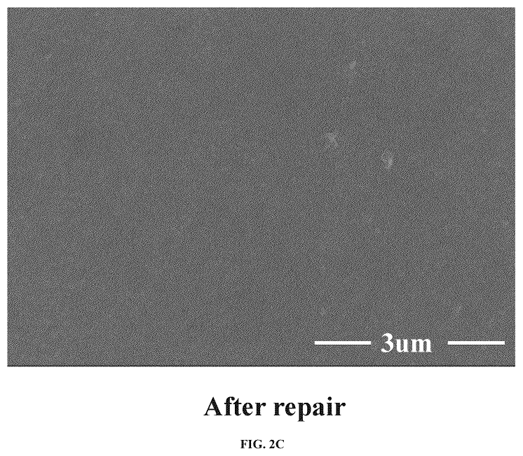

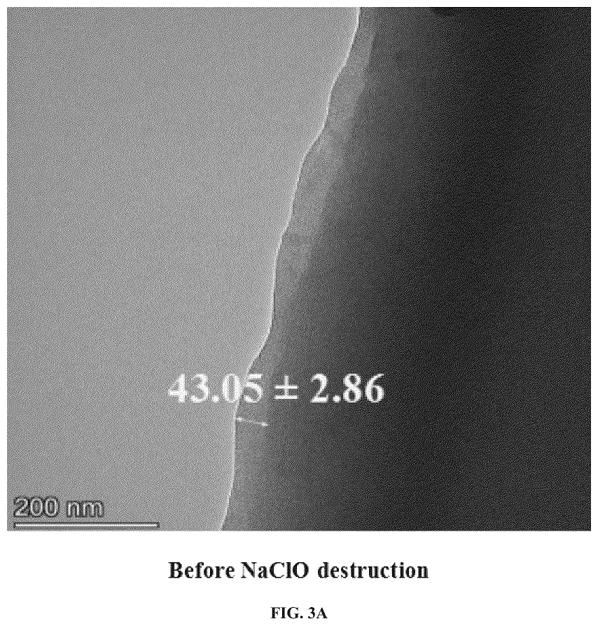

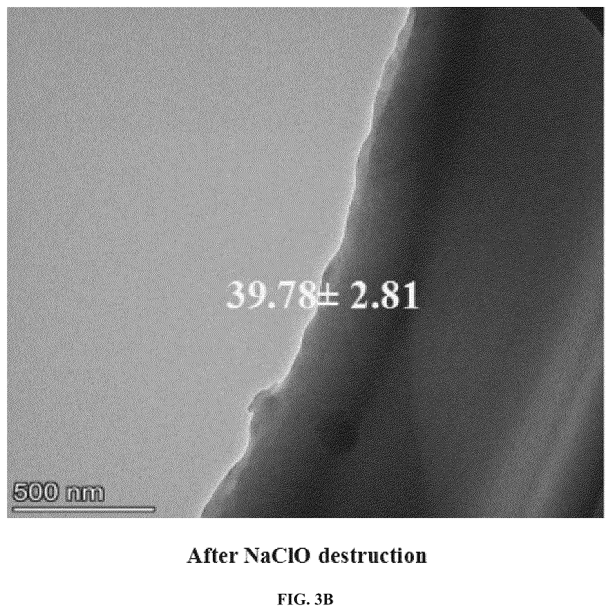

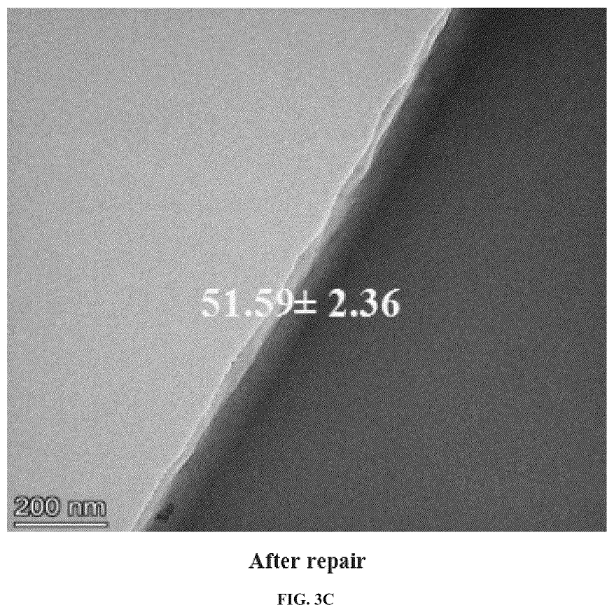

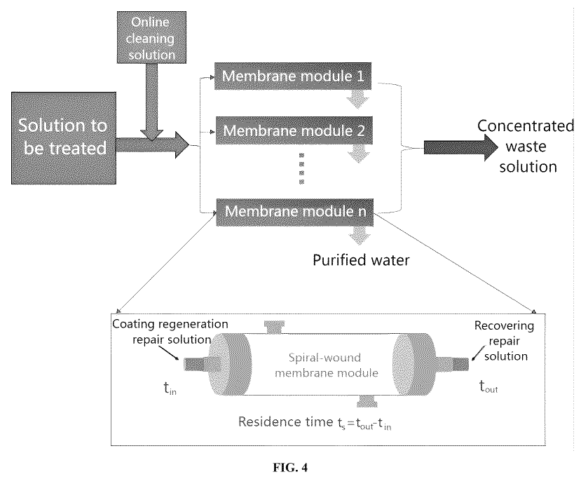

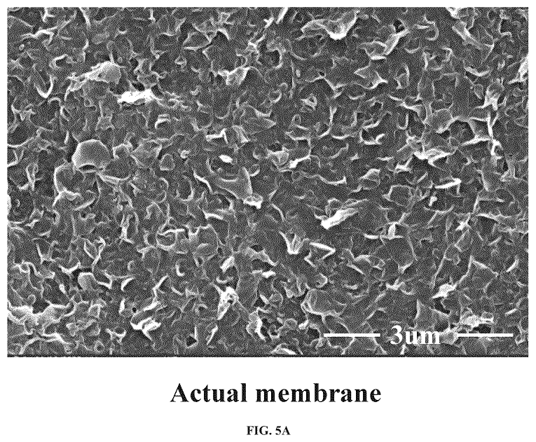

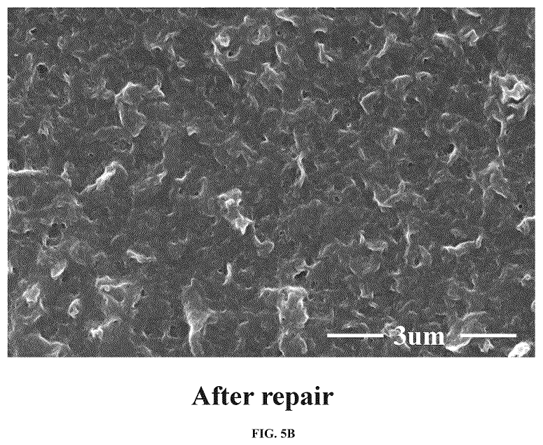

### DETAILED DESCRIPTION OF THE EMBODIMENTS

The invention is further described in combination with the embodiments and the attached drawings:

In order to achieve the above repair objectives, the technical scheme of the invention is as follows:

An environmentally friendly intermediate layer (including polydopamine, lysozyme, etc.) is constructed on the destructed PA surface. Taking the lysozyme intermediate layer as an example: the two monomers are self-polymerized on the solid surface to form a nano intermediate coating, and the second step is to use amine solution modification. The two monomers are lysozyme and tris (2-carboxyethyl) phosphine (TCEP); lysozyme is extracted from egg white; the thickness of the nano-coating is 20-150 nm.

The specific method is as follows:

The optimal ratio of lysozyme solution (1-50 mg/ml lysozyme solution dissolved in 2-300 mM HEPES solution) and tris (2-carboxyethyl) phosphine (TCEP) buffer solution (1-200 mM TCEP dissolved in HEPES solution) is selected, and the pH is adjusted to the appropriate pH environment (pH 4.0-8.0 and 2.0-7.0 respectively).

The two solutions are stirred and mixed, and then the PA membrane to be repaired is immersed in the mixed solution for 1-24 h, the surface of the membrane is rinsed with clean water to obtain a nano-coating with uniform changes in pore size, charge density and thickness, so as to repair the PA membrane.

The obtained PA membrane with nano-coating is treated in 20-80° C. and 0.1-10 g/L amine solution for 1-10 h, and then the surface of the membrane is rinsed with clean water to obtain a further optimized repaired PA membrane. Here, the molecular weight and molecular structure of the selected amine reagent will affect the efficiency of the grafting reaction, thus affecting the charge density of the PA membrane surface, which has a key effect on the repair effect.

### Embodiment 1

A repair method for PA membrane, the steps are as follows:
(1) Preparation of lysozyme solution: 2 mg/ml lysozyme solution is prepared. Specifically, lysozyme is dissolved in a configured 10 mM HEPES (solid) buffer solution;
(2) Preparation of TCEP buffer solution: 50 mM TCEP buffer solution is prepared. Specifically, TCEP is dissolved in a configured 10 mM HEPES buffer solution;
(3) The pH of the above two solutions is adjusted to 7.2 and 4.9 by using 1 mM NaOH solution respectively.
(4) The two solutions are mixed in equal volume and allowed to stand, and then the PA membrane is immersed in the mixed solution for 10 h.
(5) After the PA membrane is taken out, the membrane is rinsed with deionized water, and then the membrane is immersed in the prepared 2 g/L amine reagent solution 1 #, so as to react at 37° C. for 4 h;
(6) At the end of the reaction, the membrane is taken out, washed with deionized water, and then stored in deionized water at 4° C.

### Embodiment 2

A repair method for PA membrane, the steps are the same as those in Embodiment 1, the amine reagent solution in step (5) is replaced by amine reagent 2 # with a molecular weight of 10000.

### Embodiment 3

A repair method for PA membrane, the steps are the same as those of Embodiment 1, and the amine reagent solution in step (5) is replaced by an amine reagent 2 # with a molecular weight of 70000.

### Embodiment 4

A repair method for PA membrane, the steps are the same as those in Embodiment 1, the amine reagent solution in step (5) is replaced by amine reagent 2 # with a molecular weight of 75000.

### Embodiment 5

A repair method for PA membrane, and the steps are the same as those in Embodiment 1, the concentrations of lysozyme and TCEP in step (1) (2) are increased to 1.5 times of Embodiment 1. The reaction time in step (4) is changed to 24 h, and the amine reagent solution in step (5) is changed to amine reagent 2 # with a molecular weight of 70000.

### Ratio 1.

Commercial nanofiltration membrane NE.

### Embodiment 6

The membranes obtained from Embodiment 1, Embodiment 2, Embodiment 3, Embodiment 4, Embodiment 5 and Ratio 1 are washed with deionized water, and then the membranes are immersed in the prepared 1000 mg/L NaClO aqueous solution, so as to react at 25° C. for 30 h;

### Embodiment 7

The membrane obtained from Embodiment 6 is rinsed with deionized water, and then the steps of Embodiment 1, Embodiment 2, Embodiment 3, Embodiment 4 and Embodiment 5 are repeated.

### Ratio 2.

The actual repair method for waste membrane, the steps are as follows:
(1) The RO membrane removed from the membrane module is cut into small pieces and cleaned with tap water;
(2) The membrane washed with tap water is immersed in deionized water and placed in an ultrasonic instrument for ultrasonic treatment for 5 h.
(3) Preparation of NaOH solution, preparation of 0.1% NaOH solution. Specifically, solid NaOH is incorporated into ultrapure water;
(4) The membrane obtained by step (2) is immersed in NaOH solution and ultrasonically treated in an ultrasonic instrument for 3 h;
(5) Preparation of SDS solution, preparation of 0.025% SDS solution. Specifically, SDS powder is incorporated into ultrapure water;
(6) The membrane obtained by step (4) is immersed in SDS solution and ultrasonically treated in an ultrasonic instrument for 3 h;

### Embodiment 8

An actual repair method for waste membrane, in this embodiment, the membrane is derived from the actual spiral-wound reverse osmosis membrane module discarded during the industrial wastewater treatment process. The membrane may be subjected to a variety of common acid-base cleaning agents and oxidizing cleaning agents for a long time. The cleaning process is unknown, the cleaning agents include but not only include sodium hypochlorite solution, hydrochloric acid with low concentration, sulfuric acid, phosphoric acid, citric acid, ethylenediaminetetraacetic acid tetrasodium, sodium hydroxide, sodium dodecyl sulfonate (also known as sodium laurate), sodium bisulfite, and ammonium bisulfite. After cutting the membrane module, taking out of the waste membrane and cleaning by conventional acid-base, the repair is conducted. And the specific steps are as follows:
(1) The step is the same as that of Ratio (2);
(2) The step is the same as that of Embodiment (3);
(3) At the end of the reaction, the membrane is taken out and washed with deionized water, then stored in 4° C. deionized water.

In order to study the water permeation flux and the rejection rate of divalent cations of the surface modified nanofiltration membrane prepared by the nano-coating, the performance of the membrane is tested by a self-assembled cross-flow filtration test device in the laboratory. The water permeability coefficient and magnesium lithium rejection rate of the membrane are obtained by calculation. Table 1 shows the test results of the embodiments and ratios. Table 2 shows the test results before and after the repair of actual waste membrane.

TABLE 1
Test results of the nanofiltration membrane performance of embodiments and ratios.

| | Original | | Embodiment 6 | | Embodiment 7 | |
|---|---|---|---|---|---|---|
| | Water | Rejection | Water | Rejection | Water | Rejection |
| | permeability | rate of | permeability | rate of | permeability | rate of |
| | coefficient | Mg²⁺ | coefficient | Mg²⁺ | coefficient | Mg²⁺ |
| Group | (LMH/bar) | (%) | (LMH/bar) | (%) | (LMH/bar) | (%) |
| Ratio 2 | 13.37 | 93.72 | 12.15 | 91.55 | / | / |
| Embodiment 8 | 9.95 | 72.9 | 9.5 | 70.5 | 9.11 | 77.8 |
| Embodiment 2 | 8.81 | 90.3 | 9.53 | 45.0 | 8.67 | 91.7 |
| Embodiment 3 | 9.98 | 98.97 | 9.44 | 89.35 | 10.05 | 98.2 |
| Embodiment 4 | 9.25 | 91.4 | 8.79 | 53.6 | 8.06 | 93.0 |
| Embodiment 5 | 7.76 | 99.65 | 11.71 | 86.23 | 10.56 | 95.5 |

It can be seen from Table 1 that amine reagents with different molecular weights and different chemical structures have obvious differences in the efficiency of grafting reaction. In the table, the amine reagent 1 # used in Embodiment 1 and the amine reagent 2 # used in Embodiment 2 have different chemical structures, while the molecular weight of the amine reagent 2 #, 3 # and 4 # used in the Embodiments 2, 3 and 4 increases in turn. The data in the table show that although the amine reagents with different molecular weights and different chemical structures have obvious differences in membrane performance, they have obvious effects on the repair of PA layer after strong chlorine destruction. The water permeation flux and the rejection rate of divalent salt of the repaired NF membrane restore to 100%. The main reason for the difference in the original effect is that the positive charge on the surface of amine reagents with different molecular weights and different chemical structures is different.

By analyzing the data in the table, it is found that the nano-coating prepared by the invention has excellent water permeability coefficient and rejection rate of Mg²⁺ for the performance of nanofiltration membrane after strong chlorine action, and the nanofiltration membrane prepared by the experimental parameters in Embodiment 3 has the best performance. The rejection rate of Mg²⁺ is 98.2%, and the water permeation flux is 10.05 LMH/bar. Compared with the diamines with smaller or larger molecular weights, the nanofiltration membrane after strong chlorine destruction has the largest water permeation flux and the most significant repair effect on the rejection performance of divalent cations.

In summary, the PTL nano-coating modified nanofiltration membrane prepared by the invention introduces abundant functional groups on the surface of the original nanofiltration membrane, which reduces the pore size of the membrane, changes the surface electrical property of the membrane, and provides a more favorable surface condition for the grafting of the nanofiltration membrane surface. Therefore, the PTL protein coating is re-coated on the PTL positive charge-enhanced NF membrane after NaClO destruction, and the diamines is grafted to obtain a repair coating that can restore the NF membrane after strong chlorine destruction to the high rejection rate of divalent cations, and the repair coating has played a great role in the recovery of the performance of nanofiltration membrane after strong chlorine destruction.

Table 2 is the performance test of the actual RO membrane after coating the repair coating.

TABLE 2
Performance test of the actual waste
membrane before and after repair.

| | Water permeability | | |
|---|---|---|---|
| | coefficient | Rejection rate | Rejection rate |
| Group | (LMH/bar) | of Mg²⁺ (%) | of Na⁺ (%) |
| Ratio 2 | 7.15 | 43.5 | 49.8 |
| Embodiment 8 | 3.82 | 96.46 | 93.1 |
| Upgrade rate | | 103% | 86.9% |

It can be seen from the table that the nano repair coating prepared by the invention also has a good performance recovery effect on the actual waste membrane. Compared with the actual membrane, the RO membrane with nano repair coating has a rejection rate of 96.5% to divalent cations while ensuring the water permeation flux, which is 103% higher than that of the actual waste membrane. The rejection rate of monovalent cations is also increased by nearly 90%. Therefore, the repair coating prepared by the invention has wide applicability and remarkable repair effect.

What is claimed is:

1. An in-situ repair method for a surface of a polyamide (PA) membrane after a destruction of oxidizing substances, comprising: using a lysozyme solution to mix with a tris (2-carboxyethyl) phosphine (TCEP) buffer solution, immersing a PA membrane to be repaired in a mixed solution, and rinsing the PA membrane to be repaired after being taken out, on a surface of the PA membrane to be repaired, obtaining a nano-protein coating with uniform changes in a pore size, a charge density, and a thickness; using an amine solution modification to graft a surface of the nano-protein coating with amines to obtain a repaired PA membrane; wherein the PA membrane to be repaired is immersed in the mixed solution for 1-24 h.

2. The in-situ repair method for the surface of the PA membrane after the destruction of the oxidizing substances according to claim 1, wherein a method for grafting the amines on the surface of the nano-protein coating by using the amine solution modification is as follows: treating the PA membrane to be repaired with the nano-protein coating in a 20-80° C. and 0.1-10 g/L amine solution for 1-10 h, and rinsing a surface of a treated PA membrane with clean water.

3. The in-situ repair method for the surface of the PA membrane after the destruction of the oxidizing substances according to claim 1, wherein the lysozyme solution is 1-50 mg/ml lysozyme dissolved in a 2-300 mM 4-(2-hydroxyethyl) piperazine-1-ethanesulfonic acid (HEPES) solution.

4. The in-situ repair method for the surface of the PA membrane after the destruction of the oxidizing substances according to claim 1, wherein the TCEP buffer solution is 1-200 mM TCEP dissolved in an HEPES solution.

5. The in-situ repair method for the surface of the PA membrane after the destruction of the oxidizing substances according to claim 1, wherein a pH of the lysozyme solution is 4.0-8.0.

6. The in-situ repair method for the surface of the PA membrane after the destruction of the oxidizing substances according to claim 1, wherein a pH of the TCEP buffer solution is 2.0-7.0.

7. The in-situ repair method for the surface of the PA membrane after the destruction of the oxidizing substances according to claim 1, wherein lysozyme in the lysozyme solution adopts a natural antibacterial enzyme, and the lysozyme is extracted by an egg white.

8. The in-situ repair method for the surface of the PA membrane after the destruction of the oxidizing substances according claim 1, wherein a thickness of the nano-protein coating is 20-150 nm.

9. An on-line repair method for a membrane module without disassembling the membrane module using the in-situ repair method for the surface of the PA membrane after the destruction of the oxidizing substances according to claim 1, comprising: at an installation site of the membrane module, after cleaning the membrane module by using an on-line cleaning system, replacing a cleaning agent solution pool by the mixed solution of the lysozyme solution and the TCEP buffer solution, pumping the mixed solution into a membrane module to be repaired, after a reaction, discharging a reaction solution in the on-line cleaning system and cleaning the membrane module to be repaired, obtaining the nano-protein coating with the uniform changes in the pore size, the charge density, and the thickness on the surface of the PA membrane to be repaired, besides, replacing the cleaning agent solution pool with an amine solution, wherein the amine solution is pumped into the membrane module to be repaired, after the amine solution modification, discharging the reaction solution in the on-line cleaning system and cleaning the membrane module to be repaired, so that the surface of the nano-protein coating is grafted with the amines and a PA membrane of the membrane module is repaired.

10. A PA membrane repaired by the on-line repair method according to claim 9, wherein a nanofiltration (NF) membrane repaired after a strong chlorine destruction has a water permeability reaching 11.4 Lm⁻²L⁻¹bar⁻¹(LMH/bar) and a rejection rate to magnesium chloride reaching 98.5%, compared with the NF membrane before the strong chlorine destruction, the rejection rate to the magnesium chloride restores 100% while maintaining the water permeability.

11. The on-line repair method according to claim 9, wherein in the in-situ repair method, a method for grafting the amines on the surface of the nano-protein coating by using the amine solution modification is as follows: treating the PA membrane to be repaired with the nano-protein coating in a 20-80° C. and 0.1-10 g/L amine solution for 1-10 h, and rinsing a surface of a treated PA membrane with clean water.

12. The on-line repair method according to claim 9, wherein in the in-situ repair method, the lysozyme solution is 1-50 mg/ml lysozyme dissolved in a 2-300 mM 4-(2-hydroxyethyl) piperazine-1-ethanesulfonic acid (HEPES) solution.

13. The on-line repair method according to claim 9, wherein in the in-situ repair method, the TCEP buffer solution is 1-200 mM TCEP dissolved in an HEPES solution.

14. The on-line repair method according to claim 9, wherein in the in-situ repair method, a pH of the lysozyme solution is 4.0-8.0.

15. The on-line repair method according to claim 9, wherein in the in-situ repair method, a pH of the TCEP buffer solution is 2.0-7.0.

16. The on-line repair method according to claim 9, wherein in the in-situ repair method, lysozyme in the lysozyme solution adopts a natural antibacterial enzyme, and the lysozyme is extracted by an egg white.

17. The on-line repair method according to claim 9, wherein in the in-situ repair method, a thickness of the nano-protein coating is 20-150 nm.
